(19) United States
(12) Patent Application Publication
(10) Pub. No.: US 2005/0289008 A1
(43) Pub. Date: Dec. 29, 2005

(54) Optimized system for tracking the delivery of articles

(76) Inventors: Philip Olivier, Noves (FR); Axel Glaeser, Tauffelen (CH)

Correspondence Address: PERMAN & GREEN, 425 POST ROAD, FAIRFIELD, CT, 06824, US

(21) Appl. No.: 11/082,227

(22) Filed: Mar. 16, 2005

(30) Foreign Application Priority Data
Mar. 16, 2004 (FR) 04 02681

(51) Int. Cl. G06F 17/60

(52) U.S. Cl. 705/22

(57) ABSTRACT

A method of tracking the delivery of an article in which an addressee of the article identifies his/her/itself and signs a touch-sensitive display screen of a portable terminal held in the hand of a delivery person, the terminal also including a radio interface for transmitting this identity data and signature to a remote management computer center, the portable terminal also has an image sensor which is used to take an image of an article delivery receipt as previously filled in by the addressee, and the image is transmitted together with the identity and signature data to the management computer center in order to enable them to be consulted remotely via a telecommunications network.

### TECHNICAL FIELD

The present invention relates to the field of logistics concerning the shipping of goods, parcels, or packets, or any other article, and it relates more particularly to an optimized system for tracking the delivery of such goods.

### PRIOR ART

The logistics systems for tracking articles that are presently used by carriers are well known. For example, in U.S. Pat. No. 5,313,051, there is described a system for tracking articles which comprises a portable terminal held in the hand of a delivery person and provided with a bar code reader and a touch-sensitive screen, and also with radio communications means for transferring information to a central computer of the carrier, in particular the information input via the screen by the delivery person such as the identity and the signature of the addressee. Such a system enables the carrier to have information available in real time relating to delivered goods. Nevertheless, that information is not directly available to clients. In addition, the delivery receipt which constitutes proof of delivery can be consulted by the client only once the delivery round has been finished, and all of the receipts have been handed over to a scanner center, from which it becomes possible to consult them via a telecommunications network.

### OBJECT AND DEFINITION OF THE INVENTION

An object of the present invention is thus to mitigate the above-mentioned drawbacks by means of a method and a system for tracking the delivery of articles that enable a client of a carrier to have proof in real time of the delivery of the goods to their destination. An object of the invention is also to make consulting the transport documents needed for all goods delivery easier and more informative.

These objects are achieved with a method of tracking the delivery of an article in which an addressee of the article identifies his/her/itself on a touch-sensitive display screen of a portable terminal held in the hand of a delivery person and including a radio interface for transmitting the identity data to a remote management computer center, wherein the portable terminal has an image sensor for taking a picture of an article delivery receipt that has previously been filled in by the addressee, and said image is transmitted together with the identity data to the management computer center in order to enable them to be consulted remotely via a telecommunications network. Preferably, the image sensor means of the portable terminal are also used for taking a digital picture of the article as delivered and/or of the addressee.

Thus, the data input by the delivery person can be consulted on line immediately after it has been input, together with the photograph of the delivery receipt and a photograph of any damage that has been suffered by a defective parcel, which could constitute decisive evidence in the event of a dispute between the carrier and the carrier's client.

When the receipt does not carry the signature of the addressee of the article, provision can be made for the addressee of the article to sign on the touch-sensitive display screen of the portable terminal, with this signature then being transmitted to the management computer center together with the identity data.

Advantageously, the portable terminal has a voice recording sensor which is used for recording a voice comment by the delivery person or by the addressee, and a position sensor, e.g. of the global positioning system (GPS) type, can be used to determine the coordinates of the place where the article is delivered.

The telecommunications network is preferably the Internet.

In the intended implementation, information concerning reservations relating to the delivery, to equipment on deposit that is recovered during the delivery, and/or to sums of money received during the delivery can be input via the touch-sensitive screen of the portable terminal, with the information input via the touch-sensitive screen of the portable terminal being transmitted to the management computer center together with the other data.

The present invention also provides a portable terminal for tracking the delivery of an article, the terminal serving to receive information about the article in order to enable said information to be consulted, the terminal including a touch-sensitive display screen to enable an addressee of the article to identify his/her/itself, and further including a radio interface for transmitting the identity data and signature data to a remote management computer center, the terminal further including an image sensor for taking an image of an article delivery receipt has previously been filled in by the addressee, and wherein the radio interface transmits said image together with the identity data to the remote computer center in order to enable them to be consulted remotely via a telecommunications network.

If the receipt does not carry the signature of the addressee of the article, provision can be made for the addressee to sign directly on the touch-sensitive display screen of the portable terminal.

Advantageously, the image sensor is a sensor of the complementary metal oxide semiconductor (CMOS) type or of the charge-coupled device (CCD) type, the radio interface is a radio modem of the general packet radio service (GPRS) type or of the universal mobile telephone system (UMTS) type, and the telecommunications network is the Internet.

The terminal may also include a voice recording sensor for recording a voice commentary, and a position sensor, e.g. of the GPS type, for determining the coordinates of the place where the article is delivered. The terminal may advantageously include an integrated printer device for issuing a receipt and an integrated reader-interrogator of a radiofrequency transponder.

### BRIEF DESCRIPTION OF THE DRAWINGS

The invention will be better understood in the light of the following detailed description accompanied by non-limiting illustrative examples in the following figures, in which:

FIG. 1 is a general view showing the architecture of a computer network enabling article delivery to be tracked in accordance with the invention;

FIG. 2 shows the internal structure of a multifunction portable terminal implemented in the network architecture of FIG. 1; and

FIGS. 3 to 13 show different screen pages of the FIG. 2 terminal while tracking the delivery of articles to a destination.

### DETAILED DESCRIPTION OF EMBODIMENTS

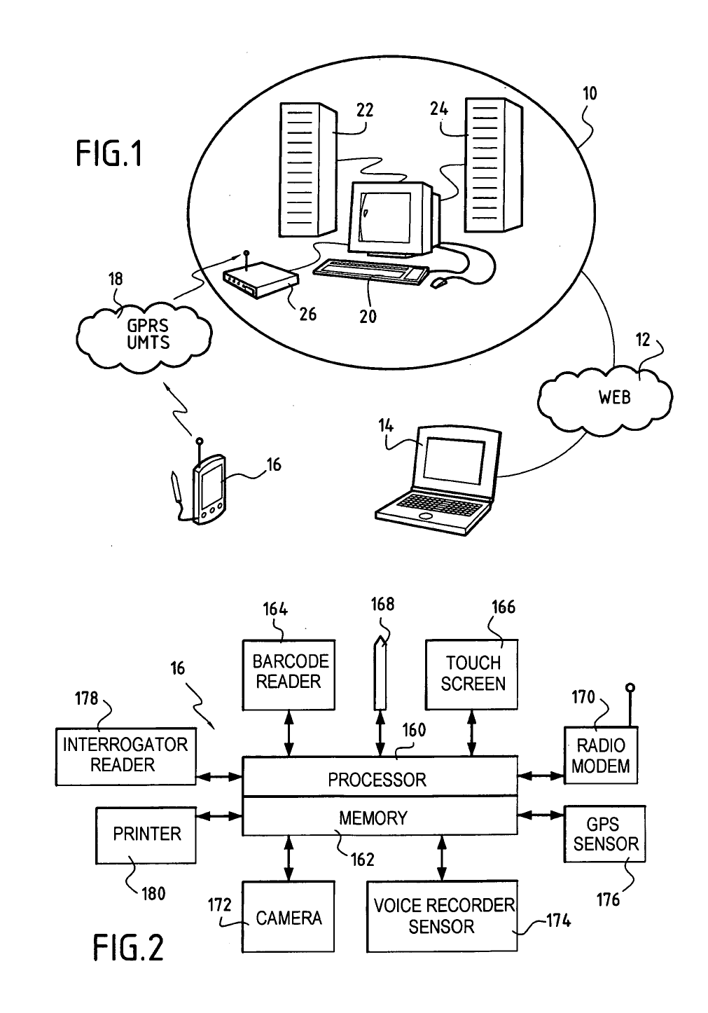

FIG. 1 shows the architecture of a computer network needed in accordance with the invention for implementing computerized tracking of the delivery of goods, parcels, or packages, or indeed any other article of the same kind, including saving and making available information relating to such goods. The invention is organized around a remote management computer center 10 connected to a first telecommunications network 12 of the Internet type. The management computer center has one or more computer servers, e.g. a server 20, associated with databases 22, 24, including an image database 22 accessible from user stations, e.g. a personal computer 14, via the Internet. The server is also provided with a radio modem 26 for receiving data from a multifunction portable terminal 16 via a second telecommunications network 18 of the GPRS or UMTS type.

With this architecture, the client of a carrier can follow the delivery of goods in real time to their destination. This tracking is performed very simply via the Internet 12 from any computer station of the client, e.g. a personal computer 14 or any other computer equipment giving access to the Internet, with the information relating to delivery (name and signature of addressee, bar code of article that has been delivered, etc.) being previously input at the destination via the multifunction portable terminal 16 held by employee of the carrier, in general a driver and delivery person, and transmitted immediately in real time via the telecommunications network 18 to the computer center 10 for managing this information. It should be observed that it is not necessary for the management computer center to belong to the carrier, and that it is quite possible for a third party to provide a delivery tracking services in its own name.

The internal structure of the multifunction portable terminal is shown in FIG. 2. It is organized around a digital processor 160 programmed to execute control instructions contained in a digital data memory 16 as a function of events occurring at its various input/output elements. It mainly comprises: a bar code reader 164 for reading a bar code generally carried by the article being shipped and providing corresponding data that is subsequently stored in the digital data memory; a touch-sensitive display screen 116 for displaying control instructions and for acting as means for inputting data (in particular the name and the signature of the addressee), which data is subsequently stored in the digital data memory; a stylus 168 for selecting control instructions and for inputting data relating to the article or to the addressee of the article, which data is read via the display screen; and a radio interface, preferably a GPRS or a UMTS radio modem 170 for establishing radio communication with the computer server 20 (via its own interface 26).

Naturally, it should be observed that the processor conventionally comprises a clock and a read-only memory (ROM) and a read-write memory (RAM), and that the stylus may optionally be replaced merely by a finger. It should also be observed that the terminal may advantageously be provided with a keypad or a keyboard.

In the invention, the terminal further comprises a digital image sensor 172 of the CMOS or CCD type, for taking an image of an article delivery receipt, which receipt is previously filled in by the addressee, and a digital voice recorder 174 for recording voice commentary by the driver or by the addressee and associated with the delivery, e.g. if a complaint is made, the digital processor being programmed to store in memory the digital data relating both to the image and to the recorded voice comment. In addition, a position sensor is preferably also provided, e.g. a GPS sensor 176, in order to determine accurately the coordinates of the place where the article is delivered, the digital processor also being programmed to store these position coordinates in the digital data memory. Naturally, the sensor may also serve to geolocate the vehicle and to track delivery during shipping. Optionally, the terminal may also include a radiofrequency transponder reader-interrogator 178 when these are provided, and advantageously a printer device 180 for delivering a receipt that the addressee can fill in or in order to replace the delivery receipt (the printer device may also be external). It should be observed that the portable terminal may advantageously be connected to a payment card reader for implementing any financial transaction that might be associated with the delivery.

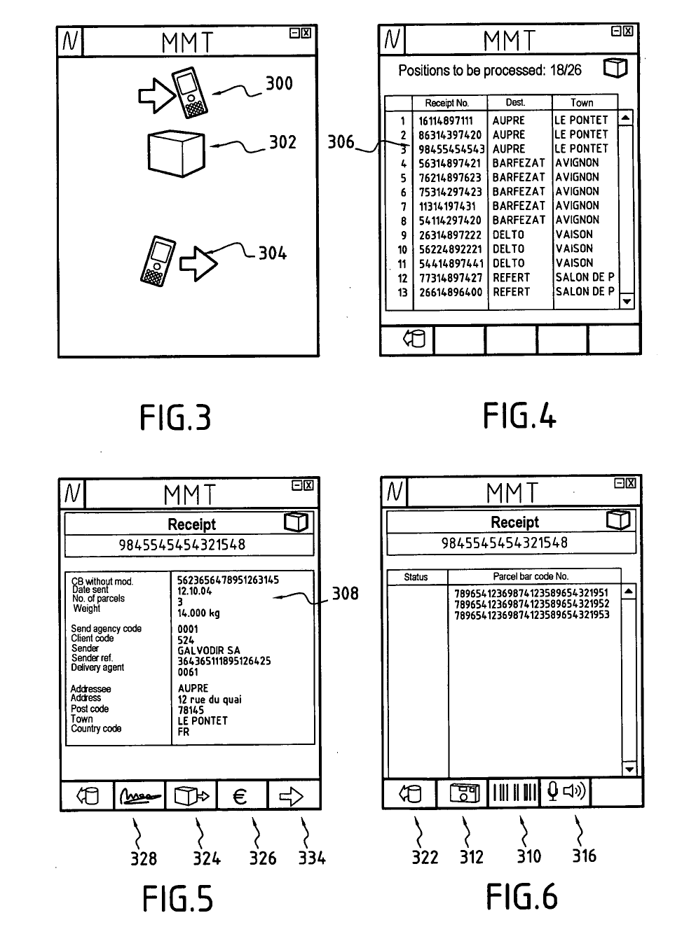

The method of the invention for tracking shipping is described below with reference to FIGS. 3 to 13 which show various screen pages that appear in succession on the multifunction portable terminal, depending on the commands selected by its user, in principle a driver delivering goods to one or more addressees.

FIG. 3 shows an example of a home page that appears on the terminal in the absence of any other action. It displays various icons corresponding to functions that are available to the driver, with access being merely by clicking, e.g. tapping with the stylus. By way of example, a first icon 300 may correspond to loading the terminal, i.e. inputting into its memory digital data concerning a list of goods to be delivered. This can be done individually from the touch-sensitive screen or from a terminal keypad (when one exists), or indeed more simply by bulk transfer from any computer station via the radio link (or any other wired or wireless link, in particular an infrared red link when the terminal has one). A second icon 302 serves to display the list of deliveries to be carried out and as previously input, in order to select a particular delivery corresponding to a determined destination. A third icon 304 serves to launch data transmission to the management computer center once all of the data relating to a given delivery has been input.

FIG. 4 is a screen page that appears after the operator has clicked on the second icon 302. It is a list of all the deliveries to be performed during a round, e.g. with each delivery being associated with a receipt number, the name of an addressee, and a destination town. The details for each delivery can be made to appear by clicking on the corresponding line.

For example, by clicking on the third line 306, the screen page shown in FIG. 5 appears which shows under the receipt number all of the information that is useful for that particular delivery, for example: sender's reference, shipping date, number of parcels concerned by the delivery, total weight of the parcels, shipping agency code, client code, sender name, delivery agency code, name and address of addressee.

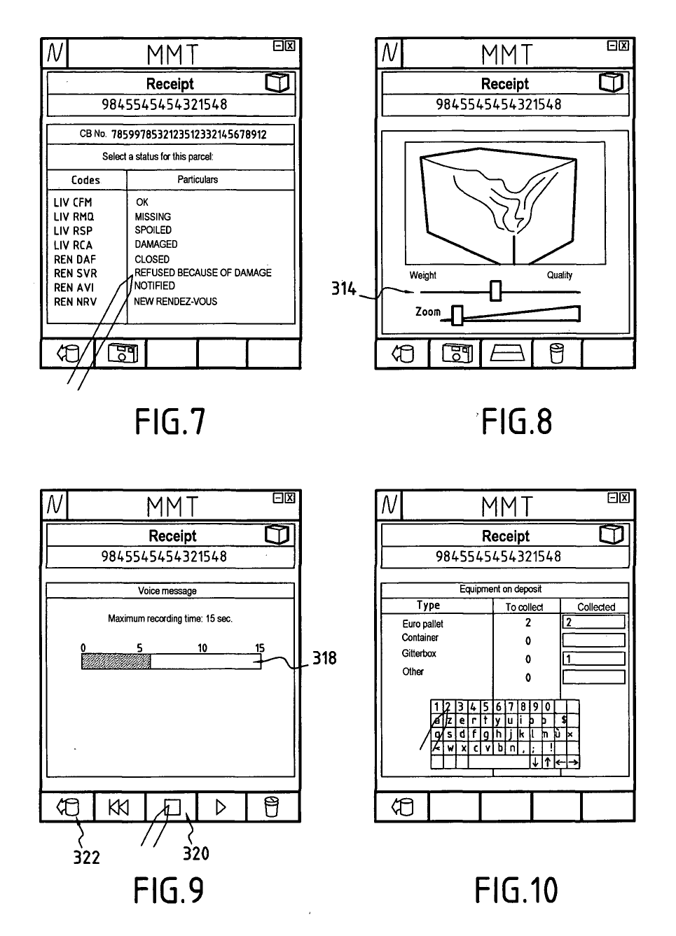

Detail about the parcels can be obtained by clicking on line 308 corresponding to a number of parcels, for example. This causes the screen page of FIG. 6 to appear showing the bar code for each of the parcels and a corresponding status that is to be filled in by the driver using the bar code reader, for which a specific icon 310 appears, e.g. at the bottom of this screen page. By acting on this icon, with the bar code reader of the terminal already pointing at a first parcel, the corresponding bar code is caused to be highlighted or made to flash, and a window for selecting a status for the parcel is caused to appear, as shown in FIG. 7. The following options can be proposed, for example: parcel OK (code LIV CFM); parcel missing (LIV RMQ), parcel refused (REN SVR), addressee absent (REN DAF), contact addressee again (REN NRV). Clicking on “parcel OK” enables the corresponding code LIV CFM to be transferred into the status column associated with the bar code that has been read. The same procedure is then applied to each of the selected parcels.

It should be observed that it is also possible to add a parcel whose bar code has just been displayed in addition to the pre-established list, for example if the operator places the bar code reader in front of a parcel not on the list. It should also be observed that this identification is generally performed in the presence of the addressee, particularly when giving the status “parcel refused”.

In addition, under such circumstances, it can be advantageous to obtain proof concerning the reason for the addressee refusing to accept the parcel by taking a photograph of the parcel that has been refused, e.g. because it is damaged. This can be done very simply by clicking on a specific icon 312 which actuates the image sensor of the terminal. The photograph that is taken then appears as shown in FIG. 8 which shows the corresponding screen page. The parameters of the image (contrast, brightness, zoom) can be adjusted if necessary in conventional manner using a control strip 314. Naturally, this function is not limited to photographing the parcel and it is entirely possible also to take a photograph of the person signing the receipt.

Similarly, acting on a comment icon 316 makes it possible, where necessary, to add a voice comment made by the driver or by the addressee, by giving access to the screen page shown in FIG. 9 which displays a gauge 318 showing the duration of the recording, for example limited to 15 seconds. A strip of controls 320 enables recording parameters to be adjusted in conventional manner. Once the recording has been made, a first click followed by a second click on a return icon 322 returns to the screen page of FIG. 5 where there are two icons that can be activated optionally, depending on the nature of the delivery.

A first of these is a deposit icon 324 which when actuated gives access to a new screen page shown in FIG. 10. Under the receipt number, this page displays the number of equipments on deposit sorted by type selected from pallets, containers, gitter box, and other, with each type of equipment being associated with the number of pieces of equipment recovered, which number is entered by the driver, e.g. by means of the stylus. This screen is thus activated only if equipment on deposit is to be delivered or recovered. A click on the return icon serves to return to the screen page shown in FIG. 5.

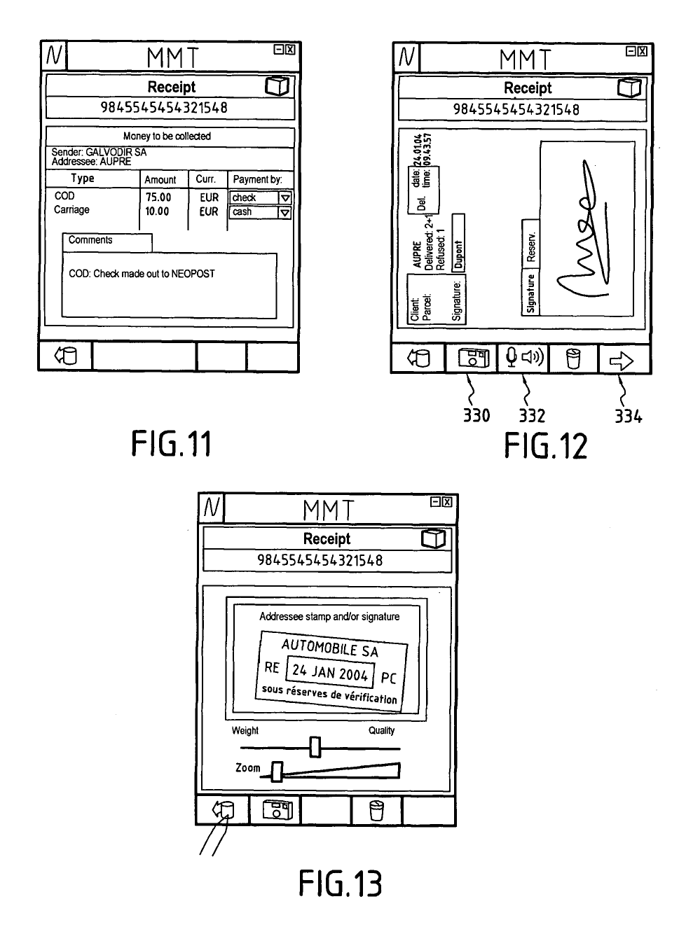

The second icon is a payment icon 326 for displaying the screen page shown in FIG. 11 giving various sums to be collected from the addressee. It is therefore activated only if the delivery is performed cash-on-delivery (COD) or implies payment for transport costs (in which case it is advantageous to give the addressee a receipt issued by the printer device of the terminal). Thus, for example, under the receipt number there may be displayed the type, the amount, and the settlement means used for paying these sums, a comments space may advantageously be provided for any remarks, e.g. that payment was performed by means of a card if the multifunction portable terminal is suitable for connection to a payment card reader. The system then returns to the screen page of FIG. 5 on clicking on the return icon.

Activating the signature icon 328 takes place on almost all occasions since that is the guarantee that the goods have indeed been received by some particular person. This is done by displaying the screen page shown in FIG. 12 which mentions the name of the person signing the delivery receipt and on which that person actually signs, possibly with reservations concerning the delivery, with these mentions being made directly on the touch-sensitive screen of the terminal by means of the stylus. To do this, the screen advantageously displays certain essential characteristics of the delivery: name of addressee, time and date of delivery, number of parcels delivered, and number of parcels refused. It should be observed that the signature on the screen can be omitted if a signature is already present on the delivery receipt. Photographs and voice comment icons 330 and 332 are directly accessible from this screen page respectively for the purpose of taking a photograph of the delivery receipt including the stamp of the addressee as shown in FIG. 13 (and possibly also a signature on the stamp) and receiving any comments made by the addressee. Once this proof of delivery has been obtained, a click on the return icon and then another click on the home icon 334 serves to return to the home page of FIG. 3, thereby immediately launching transmission of the data that has been input to the management computer center by activating the icon 304.

Once the data has been received by the management computer center, it can be consulted freely by the client, possibly after supplying an account number and a password, for example. The client thus has real time access immediately after the end of transmission, i.e. almost at the instant of delivery, to all of the data associated with the delivery, and in particular to an image of the delivery receipt, the identity and the signature of the person receiving the goods, together with reservations, if any, possibly accompanied by an image of a refused parcel and explicit comments, if necessary. The client can then make contact immediately with the addressee in order to discuss the problems encountered, thus reducing the risk of subsequent dispute.

Thus, with the method of the invention, the client is better informed and is informed immediately about any problems that the driver may encounter when making a delivery. The client also has more information about the delivery (equipment on deposit, sums paid) which can be consulted on line from any location by making access via the Internet. Such a method combines ease of use with a single portable terminal, improved performance, and an image providing delivery. In addition, the present bulk scanning of all delivery receipts, which is particularly burdensome, can be eliminated, with such receipts merely being stored in case they turn out to be useful, since the scanning is performed individually and directly by the portable terminal.

Naturally, the present invention is not limited merely to tracking the delivery of goods, and it can also be used for tracking the collection of goods from the addressee, for confirming that articles have indeed been handed over to a driver, with this being done using the driver's multifunction portable terminal. The photograph of the delivery receipt is then replaced by a photograph of a transmission sheet or a transfer sheet which the sender confirms, e.g. by signing on the terminal. All of this information that is collected relating to such shipping is then sent to the management computer center for subsequent consultation.

1. A method of tracking the delivery of an article in which an addressee of the article identifies his/her/itself on a touch-sensitive display screen of a portable terminal held in the hand of a delivery person and including a radio interface for transmitting the identity data to a remote management computer center, wherein the portable terminal has an image sensor for taking a picture of an article delivery receipt that has previously been filled in by the addressee, and said image is transmitted together with the identity data to the management computer center in order to enable them to be consulted remotely via a telecommunications network.

2. A method of tracking the delivery of an article according to claim 1, wherein the addressee of the article also signs on the touch-sensitive display screen of the portable terminal and the signature is transmitted to the management computer center together with the identity data.

3. A method of tracking the delivery of an article according to claim 1, wherein a digital image is taken by the image sensor of the portable terminal showing the delivered article and/or the addressee.

4. A method of tracking the delivery of an article according to claim 1, wherein a voice recording sensor of the portable terminal is used to record a voice comment made by the delivery person or by the addressee.

5. A method of tracking the delivery of an article according to claim 1, wherein a position sensor, e.g. of the GPS type, is also used to determine the coordinates of the place where the article is delivered.

6. A method of tracking the delivery of an article according to claim 1, wherein the telecommunications network is the Internet.

7. A method of tracking the delivery of an article according to claim 1, wherein the touch-sensitive screen of the portable terminal is also used to receive information concerning reservations about the delivery.

8. A method of tracking the delivery of an article according to claim 1, wherein the touch-sensitive display screen of the portable terminal is also used to receive information about equipment on deposit that is recovered during delivery.

9. A method of tracking the delivery of an article according to claim 1, wherein the touch-sensitive display screen of the portable terminal is also used to receive information concerning sums of money collected during delivery.

10. A method of tracking the delivery of an article according to claim 7, wherein the information received via the touch-sensitive display screen of the portable terminal is transmitted to the management computer center together with the other data.

11. A method of tracking the delivery of an article according to claim 7, wherein the information received via the touch-sensitive display screen of the portable terminal is printed by said terminal in order to issue a receipt to the addressee.

12. A portable terminal for tracking the delivery of an article, the terminal serving to receive information about the article in order to enable said information to be consulted, the terminal including a touch-sensitive display screen to enable an addressee of the article to identify his/her/itself, and further including a radio interface for transmitting the identity data and signature data to a remote management computer center, the terminal further including an image sensor for taking an image of an article delivery receipt that has previously been filled in by the addressee, and wherein the radio interface transmits said image together with the identity data to the management computer center in order to enable them to be consulted remotely via a telecommunications network.

13. A portable terminal for tracking the delivery of an article according to claim 12, wherein said touch-sensitive display screen also serves to receive the signature of the addressee of the article.

14. A portable terminal for tracking the delivery of an article according to claim 12, wherein the image sensor is of the CMOS or the CCD type.

15. A portable terminal for tracking the delivery of an article according to claim 12, further including a voice recording sensor for recording a voice comment.

16. A portable terminal for tracking the delivery of an article according to claim 12, further including a position sensor, e.g. of the GPS type, in order to determine the coordinates of the place where the article is delivered.

17. A portable terminal for tracking the delivery of an article according to claim 11, wherein the radio interface is a GPRS or UMTS radio modem.

18. A portable terminal for tracking the delivery of an article according to claim 11, wherein the telecommunications network is the Internet.

19. A portable terminal for tracking the delivery of an article according to claim 11, further including an integrated printer device for issuing a receipt.

20. A portable terminal for tracking the delivery of an article according to claim 11, further including an integrated radiofrequency transponder reader-interrogator.
